(19) United States
(12) Patent Application Publication
(10) Pub. No.: US 2003/0052844 A1
(43) Pub. Date: Mar. 20, 2003

(54) Bistable chiral nematic liquid crystal display and method of driving the same

(75) Inventors: David A. Fish, Haywards Heath (GB); Neil C. Bird, Horsham (GB)

Correspondence Address: U.S. Philips Corporation, 580 White Plains Road, Tarrytown, NY, 10591, US

(73) Assignee: KONINKLIJKE PHILIPS ELECTRONICS N.V.

(21) Appl. No.: 09/955,855

(22) Filed: Sep. 19, 2001

(51) Int. Cl. G09G 3/36

(52) U.S. Cl. 345/87

(57) ABSTRACT

A bistable chiral nematic liquid crystal display has pixel address circuits which comprise a first switching device (14) for switching a supply voltage to the remainder of the pixel address circuit and which is controlled by a row address line (10) and a second switching device (16) for allowing or preventing the supply voltage to be provided to the respective portion of the liquid crystal material (18), and controlled by a column select line (20). This pixel layout enables a transition to the H state to be avoided when the material is to remain in the P or FC states, so that the black addressing bar artifact can be avoided.

The present invention concerns a display utilizing a chiral nematic reflective bistable liquid crystal material, and a method of driving such a display. This material is also described as cholesteric. In particular, the invention relates to an active matrix pixel arrangement and drive scheme.

Cholesteric liquid crystal material is a reflective material that provides a strongly coloured binary image. The material is bistable, has a very wide viewing angle and does not require polarisers, colour filters or rubbing as do super twisted nematic (STN) type displays. Therefore, the material can provide a low power and low cost display at high resolution and with a good quality single colour image. This type of display is being proposed for hand-held portable devices as well as for electronic document viewers, such as electronic book or newspaper devices.

Cholesteric materials have three stable states. The Planar (P) state is a reflective state of the material, and is stable with zero applied field. The Focal Conic (FC) is a transmissive scattering state of the material, and is also stable with zero applied field. The Homeotropic (H) state is stable only above a high threshold voltage of around 30V, and is also transparent. A black absorbing layer placed behind the material means that the H and FC states appear black.

A fourth, instable, state also exists, which can occur upon relaxation of the material from the H state. This is called the Transient Planar (P*) state. This state only arises if the high voltage on the material in the H state is reduced rapidly, for example in 2 ms or less. The Transient Planar state relaxes to the Planar state (P) in the absence of applied voltages.

In use of the material, a drive scheme is devised to switch the material between the P and FC states, which are stable at zero applied voltage. A first problem arises because any transition between the P and FC states requires the material to pass through the high-voltage H state. Therefore, known passive matrix switching schemes require rapid high voltage switching. Conventional drive schemes are arranged such that each time a pixel is addressed, a transition in the material is provoked into the H state. This means that pixels in the reflective P state are caused to pass through the transmissive H state, even if the pixel is to be driven to the reflective P state in the next field period. This gives rise to a visual artifact known as a black addressing bar.

A further problem with this material results from the slow response time. For example, voltages need to be applied for at least 20 ms to enable state transition of the material into the H state. The material also has strong temperature dependence.

The bistable nature of the material at zero applied voltage means a display using the material does not require continuous updating or refreshing. If display information does not change, the display can be written once and remain in its information-conveying configuration for extended periods with no power consumption. This has resulted in use of cholesteric liquid crystal displays for images that can be slowly updated over relatively long periods of time. However, the problems outlined above, particularly the slow addressing response, have limited the further development of this display technology in wider fields of application.

U.S. Pat. No. 5,748,277 discloses a passive matrix addressing scheme for cholesteric displays which seeks to reduce the addressing time. The scheme relies upon the rapid transition from the H state to the P* state. If there is rapid voltage turn-off, a transition to the P* is achieved (and in turn a transition to the P state), whereas if there is slow voltage turn off, then a transition to the FC state takes place. The drive scheme provides an address voltage profile which has three phases. One of these phases is a “select phase” which is only 1 ms long and which dictates whether there is rapid or slow voltage turn off. The other two phases can be carried out simultaneously for adjacent rows, so that, for a large number of rows, the average row address period will tend towards 1 ms. Whilst this addressing scheme improves the addressing time, it does not address the other issues of temperature dependence, of rapid high voltage switching or of the black addressing bar.

According to the invention, there is provided a display apparatus comprising:

a layer of bistable chiral nematic liquid crystal material an active matrix substrate defining rows and columns of pixel address circuits, each pixel address circuit having an output for applying a signal to a respective portion of the liquid crystal material,

wherein each pixel address circuit comprises

a first switching device for switching a supply voltage to the remainder of the pixel address circuit and which is controlled by a row address line;

a second switching device for allowing or preventing the supply voltage to be provided to the respective portion of the liquid crystal material, and controlled by a column select line.

The switching devices of the pixel enable a transition to the H state to be avoided when the material is to remain in the P or FC states. In particular, if transition from the P state to the H state is avoided, the black addressing bar artifact can be avoided. The use of a row address line for the control of the first switching device and a column select line for control of the second switching device enables the supply voltage to be provided to individual pixels independently. The supply voltage is the voltage required to cause a transition of the cholesteric material to the H state.

The apparatus may further comprise a current discharge path for the respective portion of the liquid crystal material, thereby enabling the magnitude of the voltage on the respective portion of the liquid crystal material to reduce from the supply voltage magnitude. This causes the state transition from the H state to the FC or P states.

Preferably, the discharge path comprises an isolating switch and a current sink, wherein a current through the current sink is controllable to enable control of the rate at which the voltage magnitude is reduced. The control of this rate then enables a selection of whether transition is to the P* state or to the FC state. For example, the current sink may comprise a transistor with the gate connected to a capacitor, wherein the voltage across the capacitor is determined by a current mirror circuit, which samples an input current, the input current being selected to provide a desired rate of reduction of the voltage magnitude. The input current may take one of two values, one of which results in transition to the FC state, and the other of which results in transition to the P* state.

A second column select line is preferably provided for supplying the input current to the pixel. The sampling of the input current therefore must be carried out row by row. However, once the input current for one row has been sampled, the liquid crystal material can be discharged while input currents are being sampled by other rows. This means that, for a large number of rows, the row address period tends towards the duration of the control pulse on the row address line or the sampling time required to sample the input current. These are the only pixel driving signals which are not carried out simultaneously for different rows. Thus, a fast driving scheme can be implemented.

The apparatus preferably comprises a frame store for determining which pixels are to be provided with the supply voltage based on the pixel outputs in the previous and current frames.

The invention also provides a method of addressing a bistable chiral nematic liquid crystal display apparatus, the apparatus comprising an active matrix substrate defining rows and columns of pixel address circuits, each pixel address circuit having an output for applying a signal to a respective portion of the liquid crystal material, the method comprising:

selecting a row of pixels thereby providing a supply voltage to each pixel, the supply voltage being sufficient to cause the liquid crystal material to reach a homeotropic state;

determining which pixels require the respective portion of the liquid crystal material to have the supply voltage applied to them, those pixels which were in a reflecting planar state in the previous frame and which are to remain in a reflecting planar state in the current frame being determined as not requiring the supply voltage;

providing the supply voltage to those pixels determined to require the supply voltage;

providing an input current to each pixel in the row, the input current having one of two values;

sampling the input current;

causing the magnitude of the voltage on the respective portion of the liquid crystal material to change at a rate dependent on the sampled input current, wherein for those pixels supplied with the supply voltage, the first value of the input current results in the liquid crystal material adopting a reflective planar state (P), and the second value of the input current results in the liquid crystal material adopting a transmissive focal conic (FC) state.

The method enables the black addressing bar artifact to be eliminated, and avoids rapid switching of high voltages. Preferably, the first value of the input current is higher than the second value of the input current and results in a more rapid rate of change of voltage on the liquid crystal material, thereby resulting in a transition from the homeotropic state (H) to the transient planar state (P*).

Examples of the invention will now be described in detail with reference to the accompanying drawings, in which:

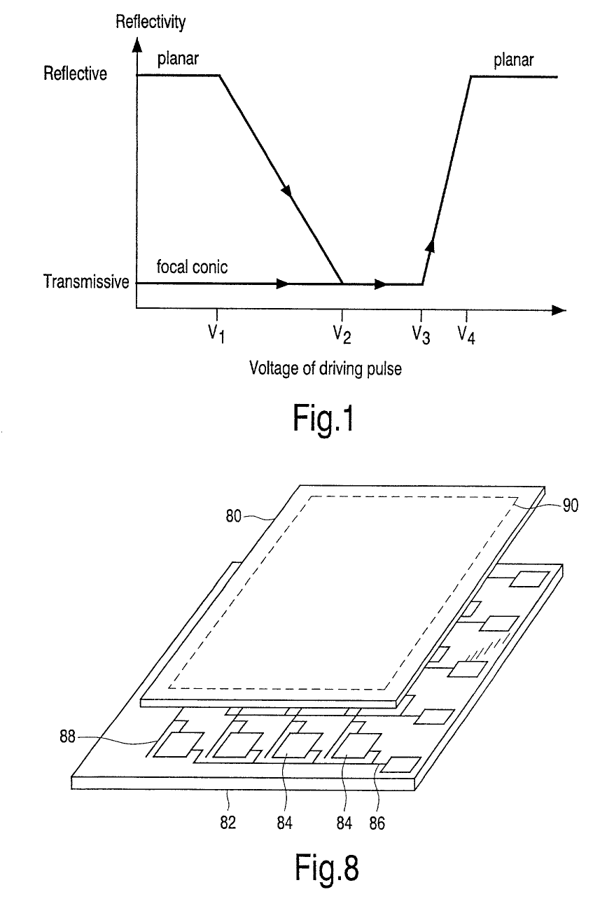

FIG. 1 shows the electro-optical response of a bistable reflective cholesteric liquid crystal;

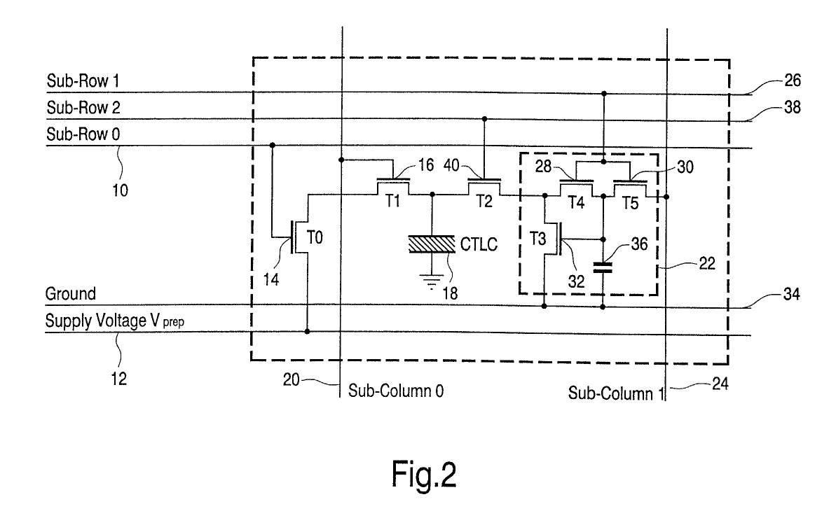

FIG. 2 shows an active matrix pixel circuit for a cholesteric display in accordance with the invention;

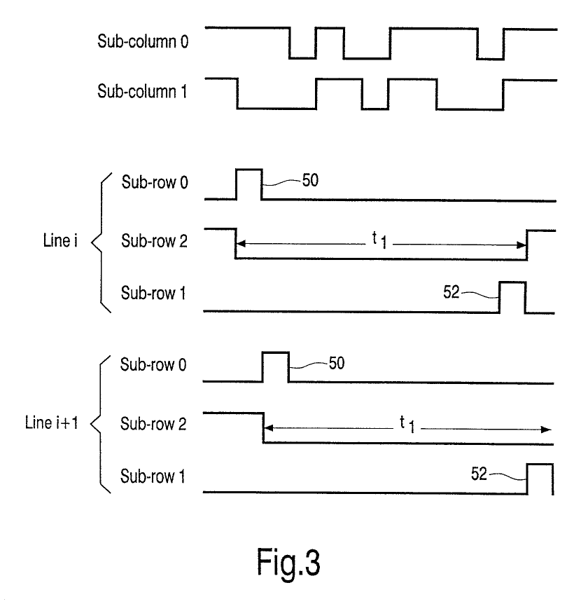

FIG. 3 is a timing diagram for the circuit of FIG. 2;

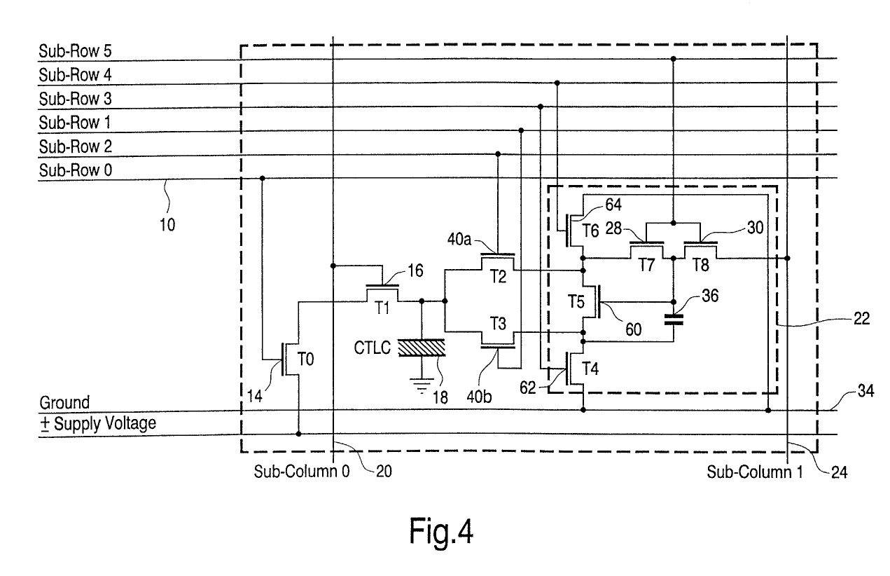

FIG. 4 shows a second active matrix pixel circuit for a cholesteric display in accordance with the invention which allows alternating supply voltages;

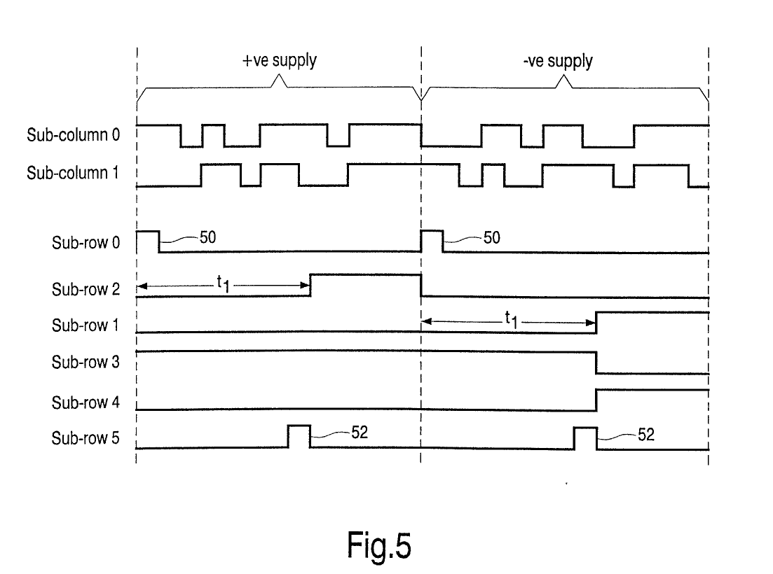

FIG. 5 is a timing diagram for the circuit of FIG. 4;

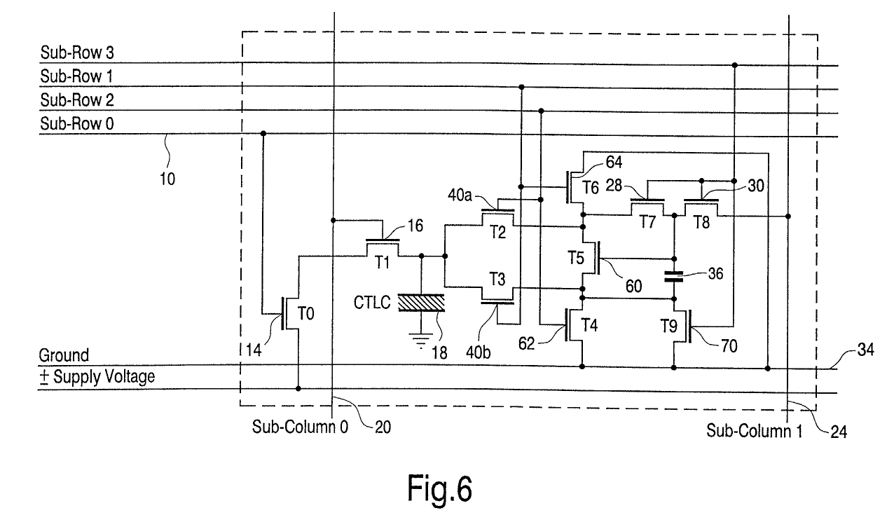

FIG. 6 shows a third active matrix pixel circuit for a cholesteric display in accordance with the invention which allows alternating supply voltages;

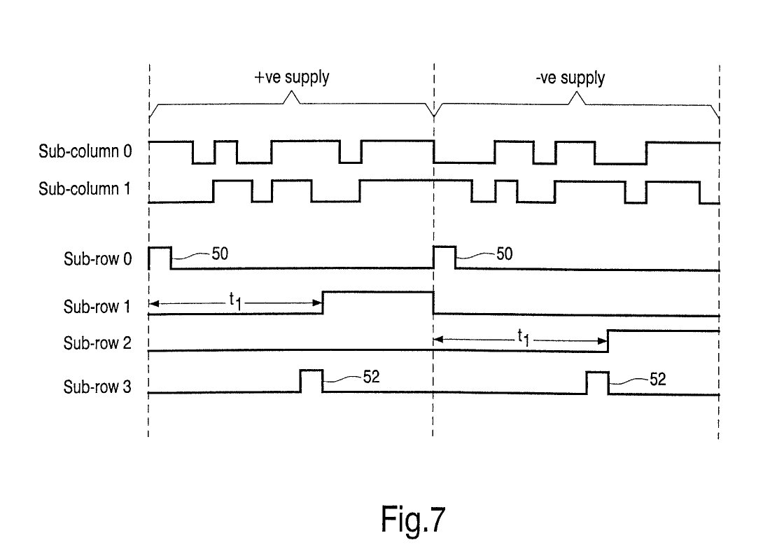

FIG. 7 is a timing diagram for the circuit of FIG. 6; and

FIG. 8 shows a display according to the invention.

The definition of “rows” and “columns” is somewhat arbitrary in the following description and claims. These terms are intended only to signify a two dimensional array of elements, with groups of elements aligned with two orthogonal axes. Thus, a “row” or “column” may run from side to side or from top to bottom of a display.

FIG. 1 shows the electro-optical response of a bistable reflective cholesteric liquid crystal. The curves show the reflectivity after application of a square wave pulse of given voltage starting either in the stable low-voltage Planar or Focal Conic state. A voltage below V₁ does not change the state of the material. A voltage pulse between V₂ and V₃ switches the material to the Focal Conic state, and a voltage above V₄ results in the Planar state. To use the material in a liquid crystal display, the material is driven to the stable Planar or Focal Conic states with low applied voltage (<V₁). However, to switch between the Planar and Focal Conic states, the material must be driven to a high voltage state (not shown in FIG. 1) in which the material is transmissive. The conditions under which this high voltage is then removed from the material dictates the manner in which the material relaxes to the stable low voltage state. If the voltage is removed rapidly, the material passes through the Transient Planar state before relaxing to the stable Planar state. If the high voltage is removed more slowly, the material relaxes to the Focal Conic low-voltage stable state.

Conventional drive schemes for cholesteric displays use a passive matrix addressing scheme, which is possible as a result of the memory effect of the liquid crystal. During each field period of the addressing scheme, the material is caused to pass into the transmissive Homeotropic state. This gives rise to the black addressing bar artefact described above.

The invention provides an active matrix addressing scheme in which the high voltage supplied to rows of pixels is selectively switchable on to the liquid crystal material of each pixel in the row. Thus, it is possible to dictate for each pixel whether or not it passes to the Homeotropic state. For pixels which are in the reflective Planar state and which are to remain in the reflective Planar state, inhibiting the Homeotropic state avoids the black addressing bar problem.

FIG. 2 shows a first active matrix pixel design of the invention. Each pixel is addressed by a first row conductor 10 “sub-row 0” which is used to address a row of pixels, and allow the high supply voltage Vₚᵣₑₚ to be supplied to the liquid crystal material. This voltage Vₚᵣₑₚ is provided on a supply voltage line 12. The row conductor 10 is coupled to the gate of a first transistor 14 which either allows or prevents the supply voltage being provided to the remainder of the pixel. When a row of pixels is addressed by the row conductor 10, all of these transistors 14 in the row are turned on so that the supply voltage reaches the remainder of the pixel for each pixel in that row. A second transistor 16 allows or prevents the supply voltage being provided to the cholesteric liquid crystal cell 18, and the gate of this second transistor 16 is provided by a column select line 20 “sub-column 0”. The row address line 10 and the column select line 20 together allow the supply voltage to be provided to or isolated from individual pixels within each row. This enables certain pixels to be isolated from the supply voltage so that these pixels are not caused to enter the Homeotropic state. In particular, if a pixel is to be driven from the reflective state in one field period to a reflective state in the next field period, the second transistor 16 is turned off by the signal on the column select line 20. Of course, this requires a field store so that the current state of the pixels can be remembered.

As described above, for those pixels where the cholesteric material is driven to the Homeotropic state, the discharge conditions from the Homeotropic state dictate whether the pixel returns to the transmissive Focal Conic state or to the reflective Planar state. To enable the discharge conditions to be controlled, a current mirror circuit 22 is provided which samples an input current on a second column select line 24 “sub-column 1”. To carry out this sampling operation, a second row conductor 26 “sub-row 1” is provided with a signal to cause the current mirror 22 to perform a sampling operation. The signal on the second row conductor 26 causes two transistors 28, 30 in the current mirror circuit 22 to become conductive so that a current flowing along the second column select line 24 passes through these two transistors 28, 30. At this stage, components of the current mirror circuit 22 are isolated from the remainder of the pixel, and the current being sampled thereby flows through a sampling transistor 32 to earth 34. When steady state conditions have been reached, the appropriate gate voltage of the sampling transistor 32 is stored on a capacitor 36. Furthermore, in this steady state there will be no flow of charge on to the capacitor 36. Ignoring the gate current of the sampling transistor 32, all current provided along the second column select line 24 will pass through the sampling transistor 32.

At the end of the sampling operation, the transistors 28, 30 are turned off, because the pulse on the second row conductor 26 terminates. The sampling transistor 32 is then isolated, but has a gate-source voltage determined by the capacitor 36 corresponding to a drain-source current equal to the current sample from the second column select line 24.

To initiate the discharge of the supply voltage from the liquid crystal material 18 a third row conductor 38 “sub-row 2” is pulsed to switch on a discharge transistor 40 which allows current to flow through the sampling transistor 32 to earth 34, thereby discharging the liquid crystal material 18. The rate at which current flows off the liquid crystal material is determined by the current flowing through the sampling transistor 32, and is therefore determined by the current provided along the second column select line 24. Thus, the second column select line 24 dictates the rate at which voltage across the liquid crystal material reduces, and thereby determines the final state of the pixel.

The timing diagram in FIG. 3 illustrates this process. As explained above, pulse 50 on the row conductor 10 allows the supply voltage to be supplied to the remainder of the pixel. The level on the first column select line 20 “sub-column 0” at this time dictates whether this supply voltage is allowed to pass to the liquid crystal material 18. Thus, the signal on the first column select line 20 oscillates between two values, with one value being maintained during a time interval corresponding at least to the duration of the pulse 50. At the end of the pulse 50, the transistor 16 is turned off so that the liquid crystal material 18 is isolated. In this way, the voltage is maintained across the material for a period of time t₁ during which the discharge transistor 40 remains closed. This time t₁ is the time during which the third row conductor 38 “sub-row 2” remains low. This is a preparation time allowing the material to reach the Homeotropic state, and will typically be between 20 and 60 milliseconds. Towards the end of the preparation time t₁, the current mirror 22 is caused to sample an input current on the second column select line 24. This is achieved by pulse 52 applied to the second row conductor 26 “sub-row 1”. The level on the second column select line 24 during this time is sampled by the current mirror 22. The signal on the second column select line 24 oscillates between two values, and maintains one of these two values during a time interval corresponding to the timing of the pulses 52.

FIG. 3 shows the timing diagram for two subsequent rows of the array. Assuming the pulses 50 and 52 have the same width, as in the example shown, the timing for adjacent rows is only displaced by the width of these pulses (plus an additional guard band to allow for the switching of signals). This is because the preparation time t₁ can overlap between adjacent pixels. Furthermore, the row pulse 50 can be applied to one row of pixels simultaneously with the second column select line current signal being sampled by pulse 52 in another row of pixels.

If the pulses 50 and 52 have different widths, the time shift between adjacent rows will correspond substantially to the duration of the longest of these two pulses. This means that a rapid addressing scheme can be implemented.

The duration of pulse 50 is dictated by how fast the liquid crystal can be charged to the supply voltage Vₚᵣₑₚ. The duration of pulse 52 is dictated by the time required to set the current mirror to its equilibrium state of operation.

The amount of high voltage switching required on the rows is reduced significantly when compared to passive matrix schemes. The transistor 14 requires the highest voltage switching capabilities, controlled by the first row conductor 10.

The pixel design of the invention enables temperature variations to be compensated for very easily. For example, the supply voltage Vₚᵣₑₚ can be modified as a function of temperature if this is required to ensure reliable transition to the Homeotropic state. Similarly, the current provided on the second column select line 24 may be varied as a function of temperature to ensure that the two current levels to be sampled enable control of the relaxation of the material in the desired manner.

The circuit of FIG. 2 shows the supply voltage Vₚᵣₑₚ as a constant voltage supplied to all pixels of the display. However, most liquid crystal materials require the field across them to be inverted at regular intervals, so that the time average voltage is zero. This is required to prevent degradation of the liquid crystal material and to prevent image retention. FIG. 4 shows a second pixel circuit which allows the supply voltage to alternate. Those components in the pixel layout of FIG. 4 which correspond to and have the same function as those of FIG. 2 are given the same reference number, and a description of those components will not be repeated.

In the pixel layout of FIG. 4, the transistors 14 and 16 again determine whether or not the supply voltage is provided to the liquid crystal material 18. However, in this circuit the supply voltage may take positive or negative values. As a result, the current mirror circuit 22 must be capable of drawing current from the liquid crystal material 18 or supplying current to the liquid crystal material, depending upon the polarity of the supply voltage. For this purpose, two discharge switches 40a, 40b are provided.

In the sampling circuit 22, the current flowing through the two sampling switches 28, 30 has two possible paths to ground 34. One of these paths is through transistors 60 and 62, and the other path is through switch 64.

If the supply voltage is positive, then the second discharge switch 40b must remain off, the transistor 64 remains off and the transistor 62 is turned on. The circuit is then equivalent to that of FIG. 2, although with an additional transistor 62 connected between the sampling circuit 22 and the ground line 34. Again, the voltage stored across the capacitor 36 corresponds to the gate-source voltage of the transistor 60 when a source-drain current flows which is equal to the current sampled from the second column select line 24. The discharge path for the liquid crystal material is through the first discharge transistor 40a and through the two transistors 60, 62 to ground 34.

If the supply voltage is negative, then the first discharge transistor 40a is turned off, the transistor 62 is turned off and the transistor 64 is turned on. The sampling operation of the current mirror circuit 22b is the same, so that a voltage is again stored on the capacitor 36 which corresponds to a given source-drain current of the transistor 60 which corresponds to the current sampled. However, the current flowing through the transistor 60 is a current to be supplied to the liquid crystal cell 18, rather than drained from it. Thus, during the discharge cycle, the current path is from ground 34, through switch 64, through switch 60, through the second discharge switch 40b to the liquid crystal material. The circuit thus operates in the same manner as that of FIG. 2, but operating at a negative voltage.

FIG. 5 shows a timing diagram similar to that shown in FIG. 3, in which the supply voltage is alternated every field period.

When the voltage supply is positive, the timing diagram corresponds to FIG. 3, with the second discharge transistor 40b turned off by sub-row 1, the transistor 62 turned on by sub-row 3 and the transistor 64 turned off by sub-row 4.

When the voltage supply is negative, the row waveforms are identical during the preparation period t₁. Thus, the current sampling, using pulse 52 again takes place with the transistor 64 turned off, and the transistor 62 turned on, and with both discharge switches 40a, 40b turned off. Once the current sampling has taken place, at the end of pulse 52, the second discharge switch 40b is turned on by sub-row 1, and in this case the transistor 64 is turned on by sub-row 4 and the transistor 62 is turned off by sub-row 3.

As shown above, the number of row conductors has increased from three to six to enable the switching of the sampled current either from the liquid crystal material to ground, or else from ground to the liquid crystal material. It is, however, possible to reduce the number of row conductors required to implement this functionality, and FIG. 6 shows a pixel circuit which reduces the number of row conductors.

It is apparent from the timing diagrams in FIG. 5 that sub-rows 1 and 4 carry the same signal both in the positive and negative supply voltage phases. A single row conductor may therefore provide this signal. Thus, in the circuit of FIG. 6, the second discharge transistor 40b and the transistors 64 are supplied by a single row line, sub-row 1. A further saving of one row conductor is achieved by connecting the transistor 62 and the first discharge switch 40a to a common control line, sub-row 2. This ensures that, during the discharge phase through the first discharge switch 40a, the transistor 62 is turned on as required. However, during the sampling phase the transistor 62 will no longer provide the required connection to ground. Therefore, an additional transistor 70 is introduced which, during the sampling stage, provides the required path to ground 34. This additional transistor 70 is controlled by the row conductor which provides the current sampling pulse 52, sub-row 3.

FIG. 7 shows a timing diagram for two phases of the circuit of FIG. 6.

FIG. 8 shows a liquid crystal display device according to the invention. The device is provided with two glass substrates 80, 82 which face each other to hold liquid crystal material between them (not shown). The lower substrate 82 is the active plate which defines the pixel layout described above. Each pixel defines a contact pad 84 for the liquid crystal material. Each pixel is addressed by a number of row conductors 86 (only one of which is shown in FIG. 8) and a number of column conductors 88 (only one of which is again shown in FIG. 8). The upper substrate 80 carries a common earth potential layer 90, so that individual regions of the liquid crystal material have a potential defined across them which is dictated by the potential on the contact pad 84.

The active plate can be manufactured using known techniques, for example using the same processes used to form the active plate of a conventional active matrix liquid crystal display. Thus, the required transistors and capacitor are formed using thin film techniques, and the transistors may be defined as amorphous silicon or polycrystalline silicon devices.

The addressing schemes of the invention enable very fast addressing to be achieved, because a short sampling period is required to sample the current which subsequently dictates the rate at which the liquid crystal is discharged. The black bar addressing artefact is removed by allowing pixels that do not need updating to be isolated. The need for rapid switching of high voltages is reduced, and the addressing scheme enables improved temperature stability or enables easy compensation for temperature variations.

Various modifications will be apparent to those skilled in the art.

1. A display apparatus comprising:
a layer of bistable chiral nematic liquid crystal material
an active matrix substrate defining rows and columns of pixel address circuits, each pixel address circuit having an output for applying a signal to a respective portion of the liquid crystal material,
wherein each pixel address circuit comprises
a first switching device for switching a supply voltage to the remainder of the pixel address circuit and which is controlled by a row address line;
a second switching device for allowing or preventing the supply voltage to be provided to the respective portion of the liquid crystal material, and controlled by a column select line.

2. Apparatus as claimed in claim 1, further comprising a current discharge path for the respective portion of the liquid crystal material, thereby enabling the magnitude of the voltage on the respective portion of the liquid crystal material to reduce from the supply voltage magnitude.

3. Apparatus as claimed in claim 2, wherein the discharge path comprises an isolating switch and a current sink, wherein a current through the current sink is controllable to enable control of the rate at which the voltage magnitude is reduced.

4. Apparatus as claimed in claim 3, wherein the current sink comprises a transistor with the gate connected to a capacitor, wherein the voltage across the capacitor is determined by a current mirror circuit, which samples an input current, the input current being selected to provide a desired rate of reduction of the voltage magnitude.

5. Apparatus as claimed in claim 4, wherein a second column select line is provided for supplying the input current to the pixel.

6. Apparatus as claimed in claim 4 or 5, wherein the current mirror circuit samples the input current with the isolating switch isolating the respective portion of the liquid crystal material from the current mirror circuit.

7. Apparatus as claimed in any one of claims 4 to 6, wherein the supply voltage oscillates between positive and negative values, and the current mirror circuit is configurable to provide a voltage across the capacitor dependent upon whether the supply voltage is positive or negative.

8. Apparatus as claimed in any preceding claim, wherein each switching device comprises a transistor.

9. Apparatus as claimed in any preceding claim, including a frame store for determining which pixels are to be provided with the supply voltage based on the pixel outputs in the previous and current frames.

10. A method of addressing a bistable chiral nematic liquid crystal display apparatus, the apparatus comprising an active matrix substrate defining rows and columns of pixel address circuits, each pixel address circuit having an output for applying a signal to a respective portion of the liquid crystal material, the method comprising:
selecting a row of pixels thereby providing a supply voltage to each pixel, the supply voltage being sufficient to cause the liquid crystal material to reach a homeotropic state;
determining which pixels require the respective portion of the liquid crystal material to have the supply voltage applied to them, those pixels which were in a reflecting planar state in the previous frame and which are to remain in a reflecting planar state in the current frame being determined as not requiring the supply voltage;
providing the supply voltage to those pixels determined to require the supply voltage;
providing an input current to each pixel in the row, the input current having one of two values;
sampling the input current;
causing the magnitude of the voltage on the respective portion of the liquid crystal material to change at a rate dependent on the sampled input current, wherein for those pixels supplied with the supply voltage, the first value of the input current results in the liquid crystal material adopting a reflective planar state, and the second value of the input current results in the liquid crystal material adopting a transmissive focal conic state.

11. A method as claimed in claim 10, wherein the first value of the input current is higher than the second value of the input current and results in a more rapid rate of change of voltage on the liquid crystal material, thereby resulting in a transition from the homeotropic state to a transient planar state.

12. A method as claimed in claim 10 or 11, wherein the supply voltage is positive for some frames and negative for other frames.
